(19) United States
(12) Patent Application Publication
(10) Pub. No.: US 2026/0003324 A1
(43) Pub. Date: Jan. 1, 2026

(54) MOON PHASE DISK, WATCH, AND METHOD FOR MANUFACTURING MOON PHASE DISK

(71) Applicant: SEIKO EPSON CORPORATION, Tokyo (JP)

(72) Inventors: Hajime HIRANO, SHIOJIRI-SHI (JP); Shohei IWABUCHI, AZUMINO-SHI (JP); Miki MATSUI, MATSUMOTO-SHI (JP)

(21) Appl. No.: 19/248,279

(22) Filed: Jun. 24, 2025

(30) Foreign Application Priority Data
Jun. 26, 2024 (JP) 2024-102835

(51) Int. Cl. G04B 19/26

(52) U.S. Cl. CPC G04B 19/268

(57) ABSTRACT

A moon phase disk is disposed on a back surface side of a dial of a watch and is visually recognizable from a moon phase display window formed in the dial. The moon phase disk includes an upper plate having a disposition hole and formed in a disk shape; a lower plate fixed to a back surface of the upper plate and formed in a disk shape; and a decorative plate disposed inside the disposition hole which is open on a front surface of the upper plate. A first diameter of the disposition hole on a front surface side of the upper plate is smaller than a second diameter of the decorative plate. And a third diameter of the disposition hole on a back surface side of the upper plate is larger than the second diameter of the decorative plate.

### CROSS-REFERENCE TO RELATED APPLICATIONS

The present application is based on, and claims priority from JP Application Serial Number 2024-102835, filed June 26, 2024, the disclosure of which is hereby incorporated by reference herein in its entirety.

### BACKGROUND

### 1. Technical Field

The present disclosure relates to a moon phase disk, a watch, and a method for manufacturing a moon phase disk.

### 2. Related Art

JP-UM-A-2-14088 discloses a moon phase display watch including a picture plate having a moon display portion formed with a moon pattern, and a dial having a moon phase window for configuring a waxing and waning of the moon. The moon display portion is configured by forming a recessed portion in a part of the picture plate and applying a phosphorescent paint to the recessed portion. Specifically, an extremely shallow recessed portion is formed in the picture plate, the recessed portion is filled, and the phosphorescent paint is applied to a surface substantially the same as an upper surface of the picture plate.

In JP-UM-A-2-14088, the paint that fills the recessed portion and the upper surface of the picture plate are substantially the same surface, and the moon display portion is limited to a planar design. Therefore, there is a demand for a moon phase disk and a watch that can obtain a three-dimensional feeling, and a method for manufacturing a moon phase disk.

### SUMMARY OF THE INVENTION

According to an aspect of the present disclosure, a moon phase disk is disposed on a back surface side of a dial of a watch and is visually recognizable from a moon phase display window formed in the dial. The moon phase disk includes: an upper plate formed in a disk shape; a lower plate fixed to a back surface of the upper plate and formed in a disk shape; and a decorative plate disposed in a disposition hole which is open on a front surface of the upper plate. A diameter of the disposition hole on a front surface side is smaller than a diameter of the decorative plate, and a diameter of the disposition hole on a back surface side is larger than the diameter of the decorative plate.

According to another aspect of the present disclosure, a watch includes: a moon phase disk; a dial having a moon phase display window exposing the moon phase disk.

According to still another aspect of the present disclosure, a method for manufacturing a moon phase disk, the method including: preparing an upper plate having a disposition hole of which a diameter on a front surface side is smaller than a diameter on a back surface side; preparing a lower plate having a moon phase toothed portion on an outer peripheral surface; pasting a double-sided adhesive sheet to a front surface of the lower plate; preparing a decorative plate having a diameter larger than the diameter of the disposition hole on the front surface side and smaller than the diameter on the back surface side; disposing a back surface of the upper plate upward to dispose the decorative plate in the disposition hole; bonding the upper plate and the lower plate by the double-sided adhesive sheet on the back surface of the upper plate with the front surface of the lower plate facing downward; and inverting up and down the upper plate and the lower plate, and pressing the decorative plate to the double- sided adhesive sheet via the disposition hole of the upper plate to be bonded.

### BRIEF DESCRIPTION OF DRAWINGS

FIG. 1 is a front view illustrating a watch of an embodiment.

FIG. 2 is a plan view illustrating the moon phase disk of the embodiment.

FIG. 3 is a cross-sectional view illustrating the moon phase disk of the embodiment.

FIGS. 4A and 4B are views illustrating an upper plate of the moon phase disk.

FIGS. 5A and 5B are views illustrating a lower plate of the moon phase disk.

FIG. 6 is a view illustrating disposing a decorative plate.

FIG. 7 is a view illustrating bonding the upper plate and the lower plate.

FIG. 8 is a view illustrating bonding the decorative plate.

### DETAILED DESCRIPTION OF THE INVENTION

Hereinafter, a watch 1 according to an embodiment will be described with reference to the drawings.

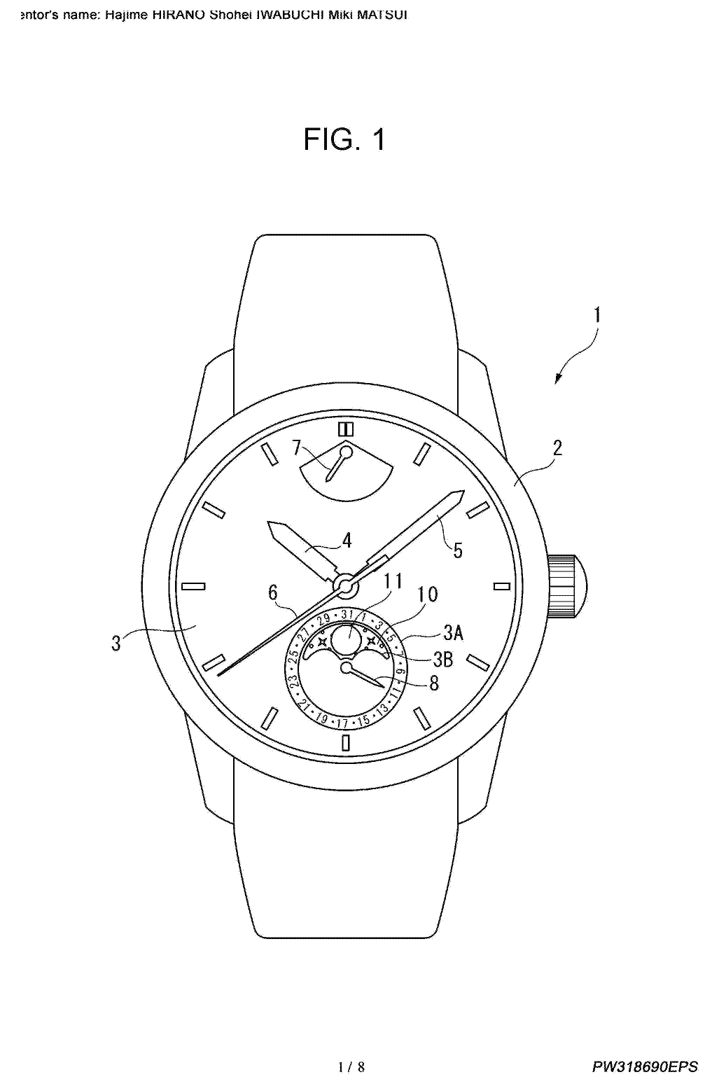

FIG. 1 is a front view illustrating the watch 1. The watch 1 of the present embodiment is a wristwatch worn on a user's wrist, includes a cylindrical exterior case 2, and the dial 3 is disposed on an inner peripheral side of the exterior case 2. Among two openings of the exterior case 2, the opening on a front surface side is closed with a cover glass, and the opening on a back surface side is closed with a case back. A movement of which a power source is a mainspring (not illustrated) is accommodated in the exterior case 2, and an oscillating weight that constitutes an automatic winding mechanism for winding the mainspring is also provided. Since the movement of the watch including the mainspring and the oscillating weight is common, the description thereof will be omitted. The type of the movement is not particularly limited, and a movement for an electronic watch having a stepping motor may be used. In addition, in the following description, the surface of each component means the surface on the cover glass side, and the back surface of each component means the surface on the case back side.

As illustrated in FIG. 1, the watch 1 includes an hour hand 4, a minute hand 5, and a second hand 6 that indicate time information, a power reserve hand 7 that indicates a winding remaining amount of the mainspring, a date hand 8, and a moon phase disk 10. The dial 3 is provided with a date display portion 3A that displays a date indicated by the date hand 8, and a moon phase display window 3B that exposes the moon phase disk 10 disposed on the back surface side of the dial 3. The moon phase display window 3B is formed in a shape that can display the waxing and waning of the moon, that is, the moon phase by the movement of a moon display portion 11 of the moon phase disk 10.

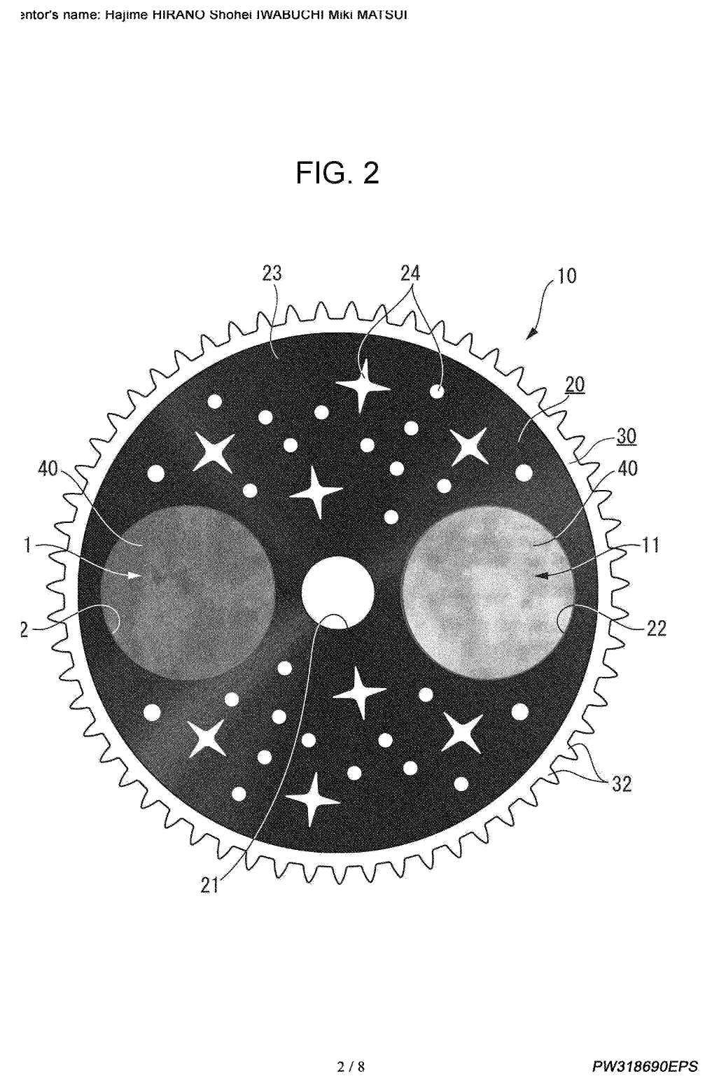

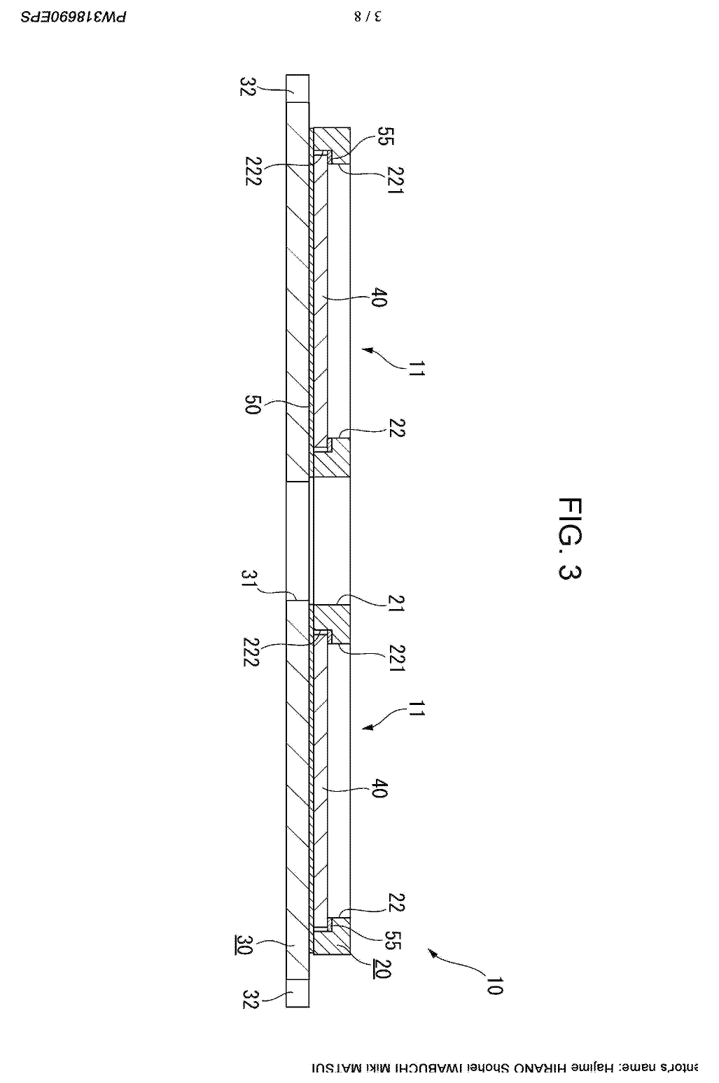

FIG. 2 is a plan view illustrating the moon phase disk 10, and FIG. 3 is a cross-sectional view illustrating the moon phase disk 10.

The moon phase disk 10 includes an upper plate 20, a lower plate 30, and a decorative plate 40.

The upper plate 20 is a disk-shaped member made of a metal material such as brass, and is provided with a through-hole 21 formed at a center of a plane and two disposition holes 22 formed to sandwich the through-hole 21. The through-hole 21 is a hole into which a moon phase disk guide seat (not illustrated) that holds the moon phase disk 10 to be rotatable is inserted. In addition, a shaft of the date hand 8 is also disposed in the through-hole 21.

The disposition hole 22 includes a small-diameter portion 221 having a planar circular shape that is open on a front surface of the upper plate 20, and a large-diameter portion 222 having a planar circular shape that is open on a back surface of the upper plate 20. The small- diameter portion 221 is formed approximately in an upper half of the upper plate 20 in a thickness direction, and the large-diameter portion 222 is formed approximately in a lower half of the upper plate 20 in the thickness direction. Therefore, in the disposition hole 22, a diameter of the opening of the upper plate 20 on the front surface side is smaller than a diameter of the opening on the back surface side. In addition, the diameter of the small- diameter portion 221 is smaller than the diameter of the decorative plate 40 described later, the diameter of the large-diameter portion 222 is larger than the diameter of the decorative plate 40, and a thickness dimension of the large-diameter portion 222 is larger than a thickness dimension of the decorative plate 40.

A base portion 23 and a star portion 24 are provided on the front surface of the upper plate 20 by painting or printing. The base portion 23 is a painted portion that images the night sky such as black or dark blue. The star portion 24 having a cross shape, a circular shape, or the like is a printed portion imaged as a star, which is printed in a bright color such as white or yellow as compared with the base portion 23.

The lower plate 30 is a disk-shaped member made of a metal material such as brass, has a larger diameter than the upper plate 20, and is a moon phase indicator having a through-hole 31 formed at a center of a plane and a moon phase toothed portion 32 formed at an outer periphery. The through-hole 31 is coaxial with the through-hole 21, and a diameter thereof has a size slightly smaller than that of the through-hole 21.

The upper plate 20 and the lower plate 30 are aligned such that the through-hole 21 and the through-hole 31 are coaxial by fitting legs 25 formed in the upper plate 20 into positioning holes 33 formed in the lower plate 30, as will be described later. In addition, the upper plate 20 and the lower plate 30 are fixed by a double-sided adhesive sheet 50 as will be described later.

The decorative plate 40 is a disk-shaped plate material constituting the moon display portion 11, and is made of mother-of-pearl in the present embodiment. Mother-of-pearl is a member having a plate shape made by slicing shells of mother-of-pearl oysters, such as white- lipped oysters, used for pearl cultivation.

The diameter of the decorative plate 40 is set to be larger than the diameter of the small-diameter portion 221 of the disposition hole 22 and smaller than the diameter of the large-diameter portion 222. In addition, the thickness dimension of the decorative plate 40 is set to be smaller than a height dimension of the large-diameter portion 222. Therefore, the decorative plate 40 can be disposed in the large-diameter portion 222 of the disposition hole 22. In addition, the back surface of the decorative plate 40 is fixed to the lower plate 30 by the double-sided adhesive sheet 50. In addition, a ring-shaped double-sided adhesive sheet 55 that also serves as a spacer is disposed between a step portion between the small-diameter portion 221 and the large-diameter portion 222 in the disposition hole 22 of the upper plate 20 and the front surface side of the decorative plate 40.

As illustrated in FIG. 2, the decorative plate 40 is exposed on the front surface of the moon phase disk 10 via the small-diameter portion 221 of the disposition hole 22. Therefore, on the moon phase disk 10, two circular moon display portions 11 formed of mother-of-pearl are displayed at an interval of 180 degrees in a rotation direction of the moon phase disk 10.

The moon phase disk 10 is intermittently rotatable every day by a moon phase jumper (not illustrated) that engages with the moon phase toothed portion 32 and a moon phase indicator driving wheel (not illustrated) that meshes with the moon phase toothed portion 32. Since one cycle of the moon phase is about 29.5 days, the two moon display portions 11 are provided at an interval of 180 degrees in the rotation direction on the moon phase disk 10. The moon phase toothed portion 32 is provided with 59 teeth such that the moon phase disk 10 rotates once every 59 days for two cycles of the moon phase.

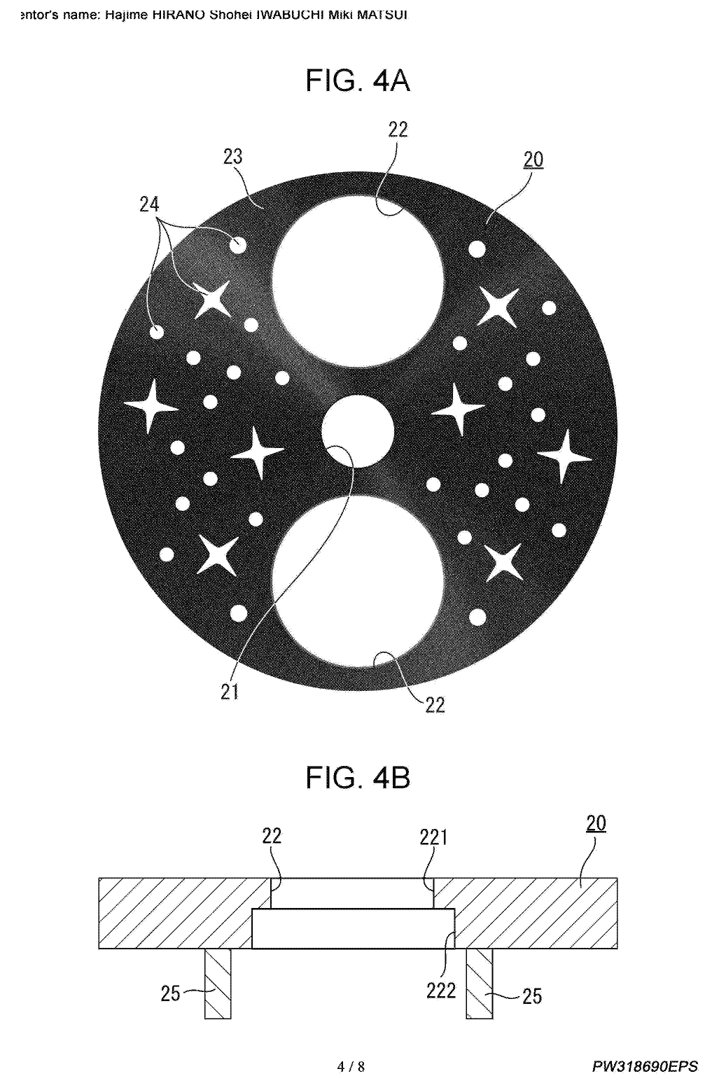

Next, a method for manufacturing the moon phase disk 10 will be described with reference to FIGS. 4A to 8. In the cross-sectional views illustrated in FIGS. 4A to 8, a ratio of the thickness dimensions of the upper plate 20 and the lower plate 30 is enlarged and schematically described.

The method for manufacturing the moon phase disk 10 includes preparing the upper plate 20, preparing the lower plate 30, pasting the double-sided adhesive sheet 50, preparing the decorative plate 40, disposing the decorative plate 40, bonding the upper plate 20 and the lower plate 30, and bonding the decorative plate 40.

In preparing the upper plate 20, as illustrated in FIGS. 4A and 4B, a plate material made of a metal such as brass is cut to be processed into a disk shape having a predetermined diameter, and the legs 25, the through-hole 21, and the disposition holes 22 are further processed to manufacture the upper plate 20. The two legs 25 are used for positioning with the lower plate 30 and are provided at two locations sandwiching the through-hole 21 in a plan view.

In a case where a pattern such as a hairline process is formed on the upper plate 20 after the cutting process, the pattern process is performed on the front surface of the upper plate 20. Next, the front surface of the upper plate 20 is plated, the base portion 23 is painted thereon, and the star portion 24 is further printed. Preparing the upper plate 20 includes each step described above.

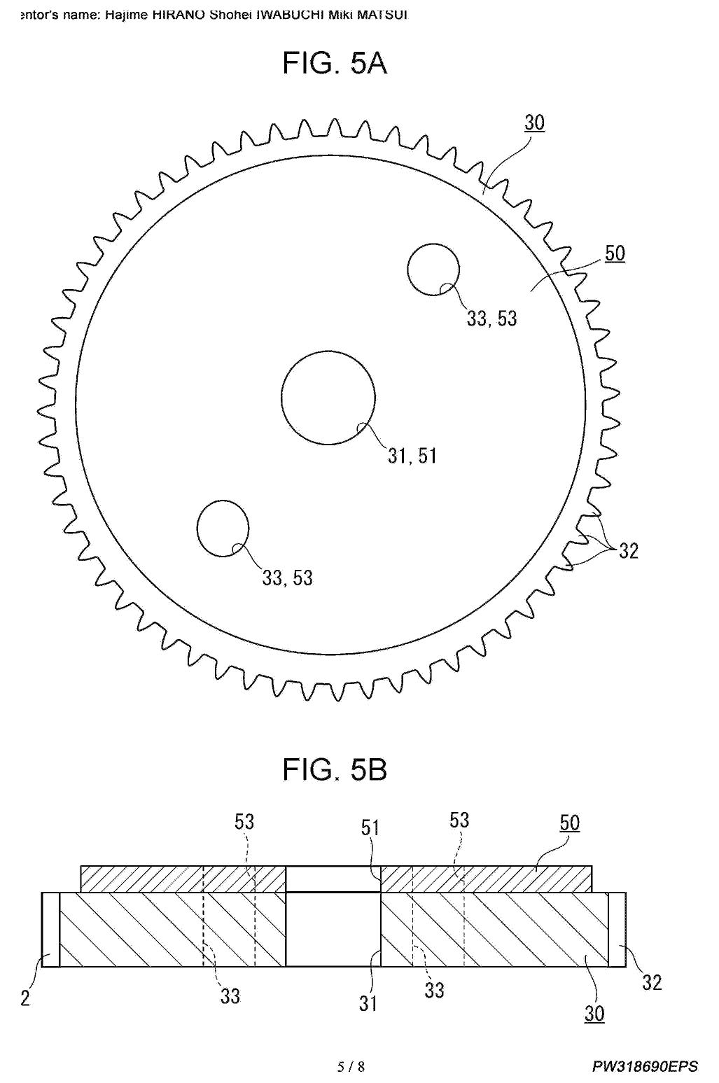

In preparing the lower plate 30, as illustrated in FIGS. 5A and 5B, a gear made of a metal in which the through-hole 31 and moon phase toothed portions 32 are formed is manufactured, and further, two positioning holes 33 are processed.

Next, preparing the double-sided adhesive sheet 50 and pasting the double-sided adhesive sheet 50 to the front surface of the lower plate 30 is executed. That is, a center hole 51 corresponding to the through-hole 31 of the lower plate 30 and positioning holes 53 corresponding to each positioning hole 33 are processed on the double-sided adhesive sheet 50 by pressing. Thereafter, the double-sided adhesive sheet 50 is pasted to the front surface of the lower plate 30.

In preparing the decorative plate 40, the decorative plate 40 is prepared by cutting the mother-of-pearl sheet into a disk shape.

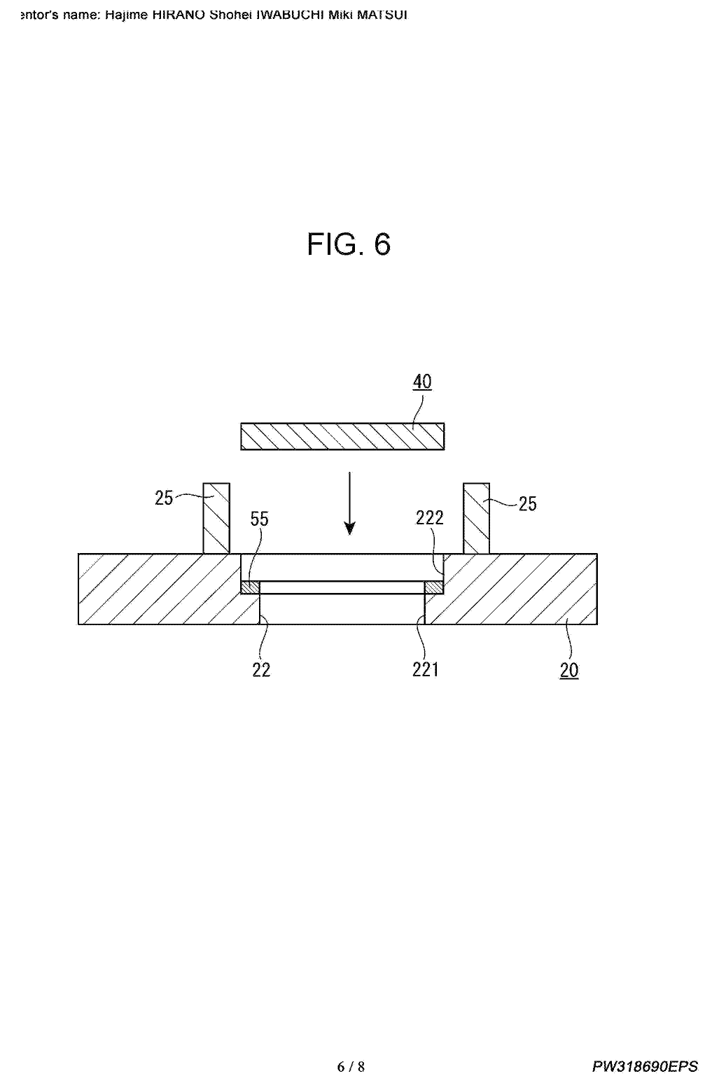

In disposing the decorative plate 40, as illustrated in FIG. 6, the back surface of the upper plate 20 is disposed upward, and the decorative plate 40 is disposed in the large- diameter portion 222 of the disposition hole 22. At this time, the decorative plate 40 is temporarily fixed in the disposition hole 22 by the ring-shaped double-sided adhesive sheet 55.

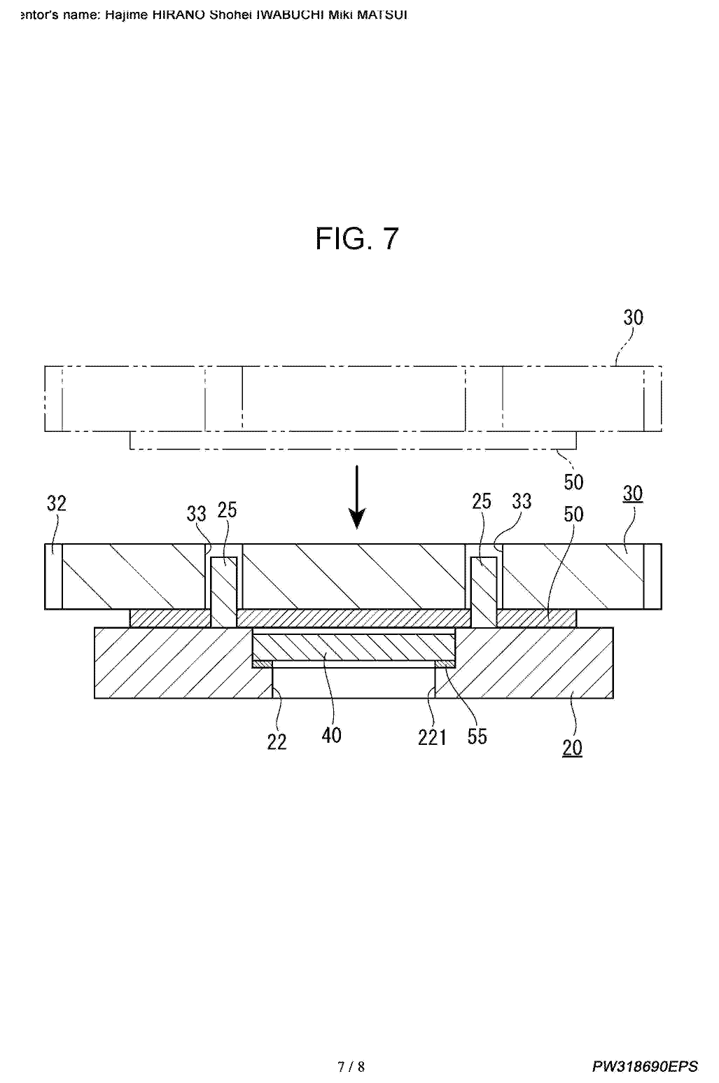

In the bonding step of the upper plate 20 and the lower plate 30, as illustrated in FIG. 7 , the double-sided adhesive sheet 50 bonded to the front surface of the lower plate 30 is pressed to the back surface of the upper plate 20 to be bonded while inserting the legs 25 of the upper plate 20 into the positioning holes 33 of the lower plate 30 with the front surface of the lower plate 30 facing downward on the back surface of the upper plate 20. As a result, the upper plate 20 and the lower plate 30 can be bonded to each other via the double-sided adhesive sheet 50.

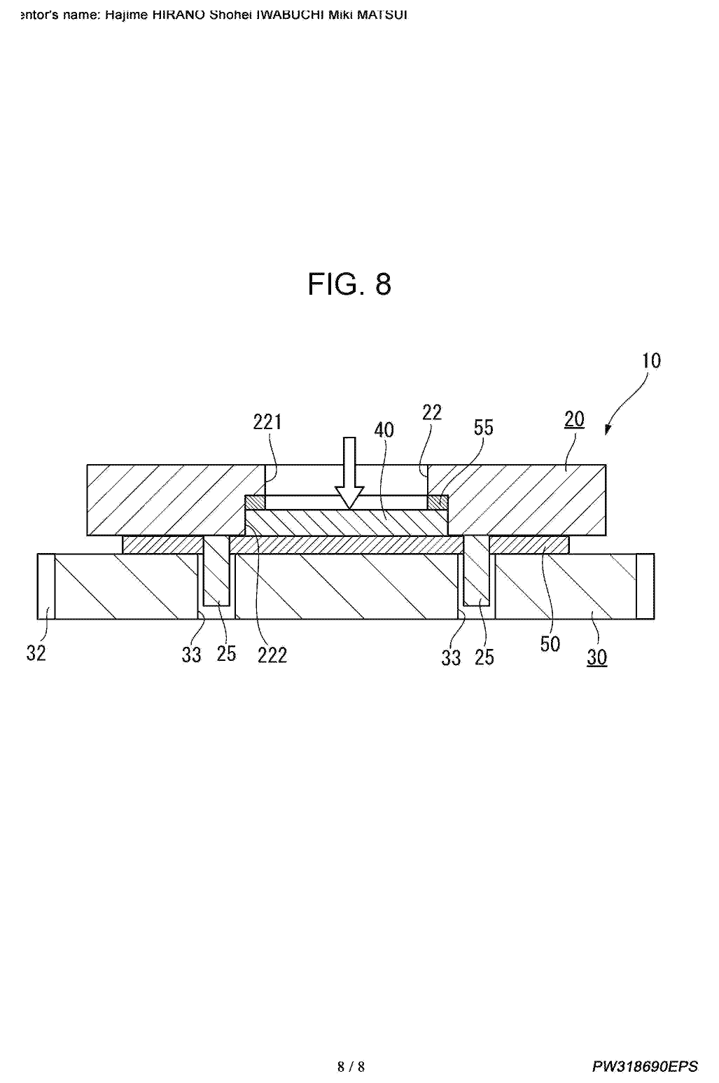

In bonding the decorative plate 40, as illustrated in FIG. 8, the upper plate 20 and the lower plate 30 are inverted up and down, and the decorative plate 40 is pressed from the disposition hole 22 of the upper plate 20 to the double-sided adhesive sheet 50 to be bonded. By each step described above, the moon phase disk 10 in which the upper plate 20, the lower plate 30, and the decorative plate 40 are bonded with the double-sided adhesive sheet 50 can be manufactured.

### Effects of Embodiment

According to the present embodiment, the decorative plate 40 is disposed in the disposition hole 22 that is open on the front surface of the upper plate 20, and thus the decorative plate 40 can be visually recognized from the moon phase display window 3B formed in the dial 3, the moon phase display by the moon display portion 11 can be expressed in a three-dimensional design, and the moon phase disk 10 having a high-class feeling can be provided.

In addition, since the diameter of the disposition hole 22 on the front surface side is smaller than the diameter of the decorative plate 40, the outer peripheral surface of the decorative plate 40 can be hidden by the upper plate 20, and the design property of the moon display portion 11 can be improved by using mother-of-pearl or the like which is difficult to perform a finishing process as the decorative plate 40.

Further, since the decorative plate 40 is disposed in the large-diameter portion 222 of the disposition hole 22, the front surface of the decorative plate 40 is disposed at a position that is more recessed than the front surface of the upper plate 20. Therefore, the decorative plate 40 does not come into direct contact with the dial 3, and it is possible to prevent the decorative plate 40 from colliding against the dial 3 and being damaged by an impact when the watch 1 is dropped or the like.

Since the disposition hole 22 is formed only in the upper plate 20, it is not necessary to process the disposition hole in the lower plate 30, and the productivity of the lower plate 30 can be improved.

Since the decorative plate 40 can be disposed in the disposition hole 22 of the upper plate 20, the upper plate 20 and the decorative plate 40 can be easily fixed to the double-sided adhesive sheet 50 pasted to the front surface of the lower plate 30, and the workability of the assembly can be improved.

Since the decorative plate 40 is also bonded to the upper plate 20 by the double-sided adhesive sheet 55, the decorative plate 40 can be temporarily fixed to the upper plate 20 until being bonded to the lower plate 30, and the workability of the assembly can be improved.

Since the upper plate 20 and the decorative plate 40 are bonded to the lower plate 30 with the double-sided adhesive sheet 50, the decorative plate 40 can be softly pasted, and when an impact is applied to the watch 1, a part of an impact force can be absorbed by the double-sided adhesive sheet 50, and the decorative plate 40 can be less likely to be damaged.

### Modification Examples

The present disclosure is not limited to each embodiment described above, and modifications, improvements, and the like within the scope that can achieve the object of the present disclosure are included in the present disclosure.

For example, the disposition hole in which the decorative plate 40 is disposed is not limited to being formed only in the upper plate 20, and may be formed in the upper plate and the lower plate. That is, a recessed portion forming the large-diameter portion in which the decorative plate 40 can be disposed may be formed on the front surface of the lower plate 30, and only the small-diameter portion may be formed on the upper plate 20. Further, the disposition hole 22 is not limited to being formed in the small-diameter portion 221 and the large-diameter portion 222. For example, a tapered disposition hole in which a diameter gradually increases from the front surface toward the back surface of the upper plate 20 may be used.

The moon phase toothed portion 32 is not limited to the one formed on the lower plate 30, and may be formed on the upper plate 20. The double-sided adhesive sheet 55 is provided between the decorative plate 40 and the upper plate 20, but the double-sided adhesive sheet 55 is not essential and may be omitted.

The upper plate 20 and the decorative plate 40 are fixed to the lower plate 30 with the double-sided adhesive sheet 50, but may be fixed with an adhesive instead of the double-sided adhesive sheet 50. The upper plate 20 and the lower plate 30 are not limited to those positioned by the legs 25 and the positioning holes 33, and may be positioned by providing positioning marks or the like.

The design of the star portion 24 printed on the front surface of the upper plate 20 is not limited to the above embodiment. In addition, a moon phase disk on which the star portion 24 is not printed may be used for the front surface of the upper plate 20.

The decorative plate 40 is not limited to the mother-of-pearl, and may be a plate material made of a metal, silicon, glass, a precious stone, a semi-precious stone, or the like.

The method for manufacturing the moon phase disk 10 is not limited to the above embodiment. For example, after the decorative plate 40 is fixed to the double-sided adhesive sheet 50 pasted to the front surface of the lower plate 30, the position of the disposition hole 22 may be aligned with the position of the decorative plate 40, and the upper plate 20 may be pasted and fixed to the double-sided adhesive sheet 50 of the lower plate 30.

### Summary of Present Disclosure

According to an aspect of the present disclosure, there is provided a moon phase disk that is disposed on a back surface side of a dial of a watch and is visually recognizable from a moon phase display window formed in the dial, the moon phase disk including: an upper plate that is formed in a disk shape; a lower plate that is fixed to a back surface of the upper plate and formed in a disk shape; and a decorative plate that is disposed in the disposition hole which is open on a front surface of the upper plate, in which a diameter of the disposition hole on a front surface side is smaller than a diameter of the decorative plate, and a diameter on a back surface side is larger than the diameter of the decorative plate.

According to the moon phase disk of the present disclosure, the decorative plate is disposed in the disposition hole that is open on the front surface of the upper plate, and thus the decorative plate can be visually recognized from the moon phase display window formed in the dial, the moon phase display can be expressed in a three-dimensional design, and the moon phase disk having a high-class feeling can be provided. In addition, since the diameter of the disposition hole on the front surface side is smaller than the diameter of the decorative plate, the outer peripheral surface of the decorative plate can be hidden by the upper plate. Therefore, the mother-of-pearl or the like which is difficult to perform a finishing process can be used as the decorative plate, and the design property can be improved. Further, since the diameter of the disposition hole on the front surface side is smaller than the diameter of the decorative plate, the front surface of the decorative plate is disposed at a position that is more recessed than the front surface of the upper plate. Therefore, the decorative plate does not come into direct contact with the dial, and it is possible to prevent the decorative plate from colliding against the dial and being damaged by an impact when the watch is dropped or the like.

In the moon phase disk of the present disclosure, it is preferable that the disposition hole is formed in the upper plate.

According to the moon phase disk of the present disclosure, the disposition hole needs only be formed in the upper plate, and it is not necessary to process the disposition hole in the lower plate, and thus the productivity can be improved. Further, since the decorative plate can be disposed in the disposition hole of the upper plate, the upper plate and the decorative plate can be easily fixed to the front surface of the lower plate with the double-sided adhesive sheet, an adhesive, or the like, and the workability of the assembly can be improved.

In the moon phase disk of the present disclosure, it is preferable that the disposition hole has a small-diameter portion of a planar circular shape that is open on the front surface of the upper plate and a large-diameter portion of a planar circular shape that is open on the back surface of the upper plate, a diameter of the small-diameter portion is smaller than the diameter of the decorative plate, a diameter of the large-diameter portion is larger than the diameter of the decorative plate, and a thickness dimension of the large-diameter portion is larger than a thickness dimension of the decorative plate.

According to the moon phase disk of the present disclosure, since the decorative plate can be disposed at the large-diameter portion of the disposition hole, the decorative plate can be stably held until the upper plate and the decorative plate are fixed to the front surface of the lower plate by the double-sided adhesive sheet, the adhesive, or the like, and the workability of the assembly can be improved. In addition, the outer peripheral portion of the decorative plate can be reliably hidden by the small-diameter portion, and the design property can be improved.

In the moon phase disk of the present disclosure, it is preferable that the upper plate and the decorative plate are fixed to a front surface of the lower plate by a double-sided adhesive sheet.

According to the moon phase disk of the present disclosure, the upper plate and the decorative plate can be easily fixed to the lower plate by the double-sided adhesive sheet. Further, since it is not necessary to fix the decorative plate by sandwiching the decorative plate between the upper plate and the lower plate, a large stress is not applied to the decorative plate, and the decorative plate can be softly pasted. Further, when an impact is applied to the watch, a part of an impact force can be absorbed by the double-sided adhesive sheet, and the decorative plate can be less likely to be damaged.

In the moon phase disk of the present disclosure, it is preferable that the upper plate is further provided with a star-shaped design.

According to the moon phase disk of the present disclosure, when the moon phase disk is rotated, since not only the moon phase display but also the star-shaped design is displayed in the moon phase display window of the dial, the design property can be improved.

In the moon phase disk of the present disclosure, it is preferable that the decorative plate is made of mother-of-pearl.

According to the moon phase disk of the present disclosure, the moon can be expressed with mother-of-pearl, and thus the design property can be improved.

According to another aspect of the present disclosure, there is provided a watch including: the moon phase disk; and a dial that has a moon phase display window exposing the moon phase disk.

According to the watch of the present disclosure, since the moon phase disk which can be expressed in a three-dimensional design and has a high-class feeling can be used, the design of the watch can be improved.

According to still another aspect of the present disclosure, there is provided a method for manufacturing a moon phase disk, the method including: preparing an upper plate having a disposition hole of which a diameter on a front surface side is smaller than a diameter on a back surface side; preparing a lower plate having a moon phase toothed portion on an outer peripheral surface; pasting a double-sided adhesive sheet to a front surface of the lower plate; preparing a decorative plate having a diameter larger than the diameter of the disposition hole on the front surface side and smaller than the diameter on the back surface side; disposing a back surface of the upper plate upward to dispose the decorative plate in the disposition hole; bonding the upper plate and the lower plate by the double-sided adhesive sheet on the back surface of the upper plate with the front surface of the lower plate facing downward; and inverting up and down the upper plate and the lower plate, and pressing the decorative plate to the double-sided adhesive sheet via the disposition hole of the upper plate to be bonded.

According to the present disclosure, the moon phase display can be expressed in a three-dimensional design, and the moon phase disk having a high-class feeling can be easily manufactured. In addition, since the diameter of the disposition hole on the front surface side is smaller than the diameter of the decorative plate, the outer peripheral surface of the decorative plate can be hidden by the upper plate, and mother-of-pearl or the like which is difficult to perform a finishing process can be used as the decorative plate. Further, the decorative plate can be easily disposed on the upper plate, and the upper plate and the decorative plate can be easily bonded to the lower plate by using the double-sided adhesive sheet, and the decorative plate can also be softly bonded.

1. A moon phase disk that is disposed on a back surface side of a dial of a watch and is visually recognizable from a moon phase display window formed in the dial, the moon phase disk comprising:an upper plate having a disposition hole and formed in a disk shape;a lower plate fixed to a back surface of the upper plate and formed in a disk shape; anda decorative plate disposed inside the disposition hole which is open on a front surface of the upper plate, wherein a first diameter of the disposition hole on a front surface side of the upper plate is smaller than a second diameter of the decorative plate, anda third diameter of the disposition hole on a back surface side of the upper plate is larger than the second diameter of the decorative plate.

2. The moon phase disk according to claim 1, wherein the disposition hole has a small-diameter portion that is open on the front surface of the upper plate and a large-diameter portion that is open on the back surface of the upper plate,the small-diameter portion and the large-diameter portion have a planar circular shape respectively,a diameter of the small-diameter portion is smaller than the second diameter of the decorative plate,a diameter of the large-diameter portion is larger than the second diameter of the decorative plate, anda length of the large-diameter portion is larger than a length of the decorative plate.

3. The moon phase disk according to claim 1, wherein
the upper plate and the decorative plate are fixed to a front surface of the lower plate by a double-sided adhesive sheet.

4. The moon phase disk according to claim 1, wherein the upper plate is further provided with a star-shaped design.

5. The moon phase disk according to claim 1, wherein the decorative plate is made of mother-of-pearl.

6. A watch comprising: the moon phase disk according to claim 1; a dial having a moon phase display window exposing the moon phase disk; and a case accommodating the moon phase disk and the dial.

7. A method for manufacturing a moon phase disk, the method comprising:preparing an upper plate having a disposition hole of which a first diameter on a front surface side is smaller than a third diameter on a back surface side;preparing a lower plate having a moon phase toothed portion on an outer peripheral surface;pasting a double-sided adhesive sheet to a front surface of the lower plate;preparing a decorative plate having a second diameter larger than the first diameter of the disposition hole on the front surface side and smaller than the third diameter on the back surface side;disposing a back surface of the upper plate upward to dispose the decorative plate in the disposition hole;bonding the upper plate and the lower plate by the double-sided adhesive sheet on the back surface of the upper plate with the front surface of the lower plate facing downward; and
inverting up and down the upper plate and the lower plate, and pressing the decorative plate to the double-sided adhesive sheet via the disposition hole of the upper plate to be bonded.
